(19) United States
(12) Patent Application Publication
(10) Pub. No.: US 2023/0331441 A1
(43) Pub. Date: Oct. 19, 2023

(54) CELLULOSE-BASED TUBE HEAD, TUBE AND MANUFACTURING METHOD

(71) Applicant: AISAPACK HOLDING SA, Vouvry (CH)

(72) Inventors: Jacques THOMASSET, Neuvecelle (FR); Gilles DEMAUREX, Martigny (CH); Joachim PELLISSIER, Fully (CH)

(21) Appl. No.: 18/025,177

(22) PCT Filed: Mar. 2, 2021
(86) PCT No.: PCT/IB2021/051722

§ 371 Date: Mar. 7, 2023

(30) Foreign Application Priority Data
Sep. 8, 2020 (EP) 20195175.3

(51) Int. Cl. B65D 35/14; B65D 35/10; B65D 35/44; B65D 35/12; D21H 19/22

(52) U.S. Cl. CPC B65D 35/10; B65D 35/12; B65D 35/14; B65D 35/44; D21H 19/22

(57) ABSTRACT

The invention relates to a tube part, for example a tube head or a cap, the part comprising a structural portion and at least one functional portion, the structural portion having a high cellulose content and the functional portion having a reduced cellulose content. The invention also relates to a package comprising at least one such part and a method for manufacturing the part for the package, and the package.

### CORRESPONDING APPLICATION

The present application claims priority over the prior European application number 20195175.3 filed Sep. 8, 2020 in the name of AISAPACK HOLDING SA, this prior application being incorporated by reference in its entirety in the present application.

### TECHNICAL FIELD

The present invention relates to a packaging component and a cellulose-based packaging. More specifically, the invention relates to a cellulose-based tube head, a cellulose-based opening/closure system and the cellulose-based packaging which is obtained therefrom. The present invention applies to the field of packaging and, in particular, but in a non-limiting manner, to that of the flexible tubes intended to contain creams or pastes such as toothpaste. The invention relates also to a method for producing this packaging.

### STATE OF THE ART

Many flexible packagings comprise several distinct parts. In the case of a tube, there is, for example, a first part forming a flexible cylinder and that is advantageously manufactured by welding a single-layer or multilayer sheet. This part of the packaging can be easily manufactured from sheets containing a high cellulose content such as sheets of paper. In the tubes, there is a second part, called tube head, which is a three-dimensional part manufactured by molding and comprising functional parts for the opening and the closure of the packaging. This part of the packaging is difficult to produce in a cellulose-based material for reasons both of performance of the packaging (impermeability to moisture) and method (difficulty in producing three-dimensional parts at a high rate). The packaging finally comprises a third part which is the opening and closure system and which generally takes the form of a screwed or snap-fitted cap. This third element is also difficult to produce in a cellulose-based material because of its three-dimensional geometry.

One object and one aim of the invention is notably to remedy these difficulties and make it possible to propose packagings with a high cellulose content allowing them to be recycled in the paper industry.

### SUMMARY AND PRINCIPLE OF THE INVENTION

The invention relates to packaging components comprising a cellulose-based structural part and one or more resin-based overmolded functional parts. The invention relates notably to tube heads and opening and closure systems such as caps.

A first aspect of the invention relates to a cellulose-based tube head. According to a first mode of execution of the invention, the tube head comprises a structural part with a high cellulose content and at least one functional part with a lower cellulose content. The tube head comprises a first functional part on its periphery allowing the tube head and the skirt to be assembled. The tube head also comprises a second functional part in the central part allowing the fixing of a cap for opening and closing the packaging. The second functional part notably makes it possible to obtain a sealing function of the packaging when the cap is closed. The functional parts also make it possible to protect the ends of the cellulose-based structural part from moisture.

The invention makes it possible to minimize the quantity of functional material which is not cellulose-based. According to the invention, the cellulose content in the tube head is greater than 50%, advantageously greater than 70% and preferably greater than 85%.

In embodiments, the invention relates to a packaging part, such as a tube, said part being, for example, a tube head or a cap or a bottom or capsule body, said part comprising a structural part and at least one functional part, the structural part having a high cellulose content and the functional part having a lower cellulose content.

In embodiments, the cellulose content of the structural part is at least greater than 50%, advantageously greater than 70% and preferably greater than 85%.

In embodiments, the structural part has a single-layer or multilayer cellulose-based structure.

In embodiments, said part can be a tube head or a capsule body for example.

In embodiments, the multilayer structure is, from the outer face toward the inner face:
paper/PE or paper/PP or paper/coating
PE/paper/PE or PP/paper/PP or coating/paper/coating
coating/paper/PVOH/PE
PE/paper/PE-EVOH-PE
PE/paper/barrier PET/PE
OPP/paper/barrier OPP/PP
coating/PVOH/paper/PE
PE-EVOH-PE/paper/PE
barrier OPP/paper/PP

In embodiments, the outer layer is a layer of coating type and/or a lacquer/varnish.

In embodiments, the structural part is manufactured from a multilayer sheet containing a cellulose content preferably greater than 50%.

In embodiments, the tube head can comprise at least, as functional part
a welding zone,
encapsulation zones of the ends of the structural part,
assembly means for assembling the tube head with a cap,
sealing means between the tube head and the cap,
an orifice.

In embodiments, the functional part is made of resin such as, for example:
PE or PP or PVOH
PLA or other biosourced resin
biodegradable resins
cold or hot glues
or multilayer.

In embodiments, the packaging part is a cap.

In embodiments, the multilayer structure of the structural part comprises, for example, from the outer face to the inner face:
paper
paper/PE
paper/PP
coating/paper/PE
coating/paper/PP
coating/paper/coating
PE/paper/PE
PP/paper/PP
coating/PVOH/paper/PVOH/coating.

In embodiments, the structural part is manufactured from a multilayer sheet containing a cellulose content greater than 60% and preferably greater than 80%.

In embodiments, the cap comprises, at least as functional part:
assembly means for assembling the cap with the tube head,
sealing means between the cap and the tube head,
an encapsulation zone of the ends of the structural part.

In embodiments, the functional part is made of resin such as, for example:
PE or PP or PVOH
PLA or other biosourced resin
biodegradable resins
cold or hot glues
or multilayer.

In embodiments, the functional part is a packaging bottom.

In embodiments, the bottom comprises a cellulose-based structural part and resin-based functional parts.

In embodiments, the invention relates to a packaging comprising at least one part as defined in the present application.

In embodiments, the packaging is, for example, a tube or a flask or a bottle or a can or a capsule or a pot.

In embodiments, the packaging has a cellulose content greater than 50% and preferably greater than 70%, or preferentially an overall cellulose content greater than 85%.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1 to 6 illustrate examples of cellulose-based tube heads according to the invention. The tube heads comprise at least 50% cellulose and preferably at least 70% cellulose.

FIGS. 7 to 9 illustrate examples of ribs which link the functional parts.

FIGS. 10 and 11 illustrate examples of the functional zone which makes it possible to make the link between the tube head and the skirt.

FIGS. 12 and 13 illustrate examples of cellulose-based caps according to the invention.

FIGS. 14 and 15 illustrate examples of cellulose-based packagings produced according to the invention and comprising at least a cellulose-based skirt, a cellulose-based tube head and a cellulose-based cap.

FIG. 16 illustrates a cellulose-based tube head according to the invention which can be stacked easily.

FIG. 17 illustrates the stacking of the tube heads illustrated in FIG. 16.

FIG. 18 illustrates another example of a packaging component, in this case a bottom.

FIGS. 19 to 23 illustrate exemplary embodiments of packagings according to the invention.

FIG. 19 illustrates a flexible tube for liquid, viscous or pasty products.

FIG. 20 illustrates a flask or a bottle for liquid products.

FIG. 21 illustrates a packaging of can type for liquid or solid products in powder or granule form.

FIG. 22 illustrates a packaging of capsule type for powder or liquid products.

FIG. 23 illustrates a packaging of pot type with screwed or snap-fitted cover for solid powder or granule products or for pasty products or for viscous products.

### DETAILED DESCRIPTION

| | |
|---|---|
| 1: | tube head |
| 2: | tube head structural part |
| 3: | welding zone |
| 4: | staircase |
| 5: | encapsulation zone |
| 6: | encapsulation zone |
| 7: | assembly means of the tube head |
| 8: | sealing means of the tube head |
| 9: | tube head orifice |
| 10: | feed rib |
| 11: | skirt |
| 12: | cap |
| 13: | structural part of the cap |
| 14: | sealing means of the cap |
| 15: | welded or glued interface |
| 16: | encapsulation zone |
| 17: | assembly means of the cap |
| 18: | cap seat |
| 19: | cap cover |
| 20: | hinge |
| 21: | sealing means of the cover |
| 22: | cover closure end-fitting |
| 23: | welded or glued interface |
| 24: | seat orifice |
| 25: | packaging bottom |
| 26: | structural part of the bottom |
| 27: | welding zone |
| 28: | staircase |
| 29: | encapsulation zone |
| 30: | neck |
| 31: | lid 32: conical body 33: collar |
| 34: | functional part |
| 100: | packaging of the tube type |
| 101: | packaging of the flask or bottle type |
| 102: | packaging of the can type |
| 103: | packaging of the capsule type |
| 104: | packaging of the pot type. |

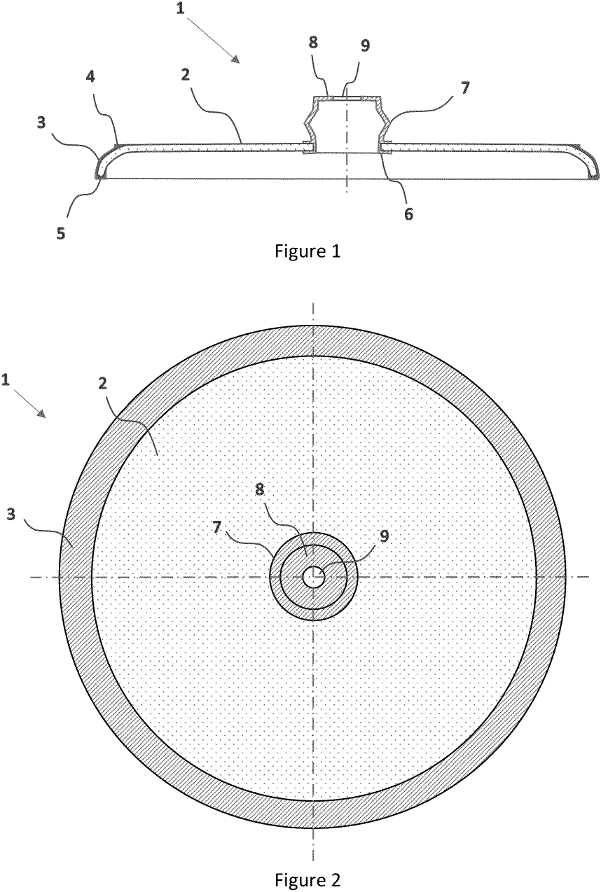

FIGS. 1 to 6 illustrate examples of cellulose-based tube heads according to the invention. The tube heads of FIGS. 1, 3, 4 and 5 are presented in cross section.

FIG. 1 illustrates a cellulose-based tube head according to the invention. The tube head 1 comprises a first cellulose-based structural part 2 and resin-based functional parts 3, 4, 5, 6, 7, 8.

The cellulose-based structural part 2 is preferably a multilayer structure with a high cellulose content. The structural part 2 has barrier properties except at its ends. According to a preferential embodiment, the structural part 2 has barrier properties to water and to steam and barrier properties to oxygen or to aromas or even to oil. Examples of multilayer structures of the structural part 2 are as follows, described from the outer face to the inner face:
paper or paper/coating or coating/paper or coating/paper/coating
paper/PE or PE/paper or PE/paper/PE
paper/PP or PP/paper or PP/paper/PP
coating/paper/PVOH-PE or PE-PVOH/paper/coating
PE/paper/PE-EVOH-PE or PE-EVOH-PE/paper/PE
PE/paper/barrier PET-PE or PE-barrier PET/paper/PE
OPP/paper/barrier OPP-PP or PP-barrier OPP/paper/OPP
coating/PVOH/paper/PE
barrier OPP/paper/PP

The structural part 2 contains a high cellulose fiber content. According to a preferential embodiment, the cellulose fibers come from the paper industry. The cellulose fibers can be of first use or derived from recycling.

According to an alternative embodiment, the structural part 2 contains natural fibers such as wood fibers or semi-transformed products derived from the wood industry. Other equivalent materials are possible.

The outer layer can be replaced by coatings or lacquer. The thickness of the structural part 2 is between 300 and 1500 microns and preferably between 700 and 1200 microns. The structural part 2 is advantageously manufactured from a multilayer sheet containing a cellulose content greater than 50% and preferably greater than 70%. The structural part 2 can also be obtained by cellulose molding.

FIG. 1 illustrates a tube head comprising the following functional parts:
a welding zone 3 limited by a staircase 4,
encapsulation zones 5 and 6 of the ends of the structural part 2,
assembly means 7 for assembling the tube head with a cap,
sealing means 8 between the tube head 1 and the cap,
an orifice 9.

These functional parts are made of resin such as, for example:
PE or PP or PVOH
PLA or other biosourced resin
biodegradable resins
cold or hot glues
multilayer structure such as, for example, PE/PVOH or PE/EVOH/PE or PP/PVOH or PP/EVOH/PP.

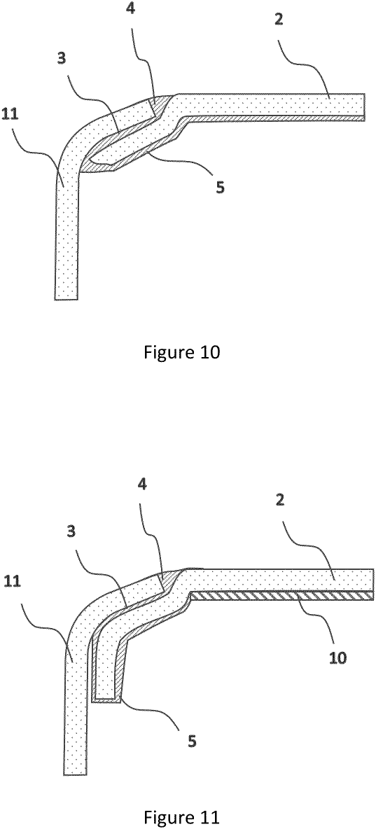

The welding zone 3 provides the link between the tube skirt 11 (see FIGS. 10 and 11) and the tube head 1. The welding zone is delimited by a staircase 4 used to encapsulate the ends of the skirt 11 which is preferably cellulose-based. The assembling of the tube head 1 and the skirt 11 is done by welding or by overmolding for example. Other equivalent methods are of course possible.

The encapsulation zones 5 and 6 make it possible, for example, to protect the ends of the structural part 2 from moisture. More generally, the encapsulation zones avoid the migration of liquid or gaseous products into the cellulose-based structural part. The encapsulation zones also avoid the migration into the packaging of molecules contained in the cellulose-based structural part 2.

The assembly means 7 allow a cap to be fixed onto the tube head for the opening and the closure of the packaging. The fixing means are, for example, a threading if the cap is screwed onto the tube head, or even means for fixing the cap by snap-fitting if the cap has a hinged opening/closure system.

The tube head advantageously also has sealing means to allow the tube head with the cap to be sealed.

The functional zones 3, 4, 5, 7, 8 and 9 are obtained, for example, by an overmolding method based on injection of the cellulose-based structural part 2 (see application WO 2018/073735 which is incorporated by reference). An alternative method consists in using a compression molding method to overmold the cellulose-based structural part 2. Another alternative method consists in welding or gluing a single-layer or multilayer film to form the functional zones 3, 4, 5 and 6.

FIG. 2 illustrates, in a top view, the tube head presented in FIG. 1. FIGS. 1 and 2 give an understanding of the spirit of the invention which is to maximize the cellulose content in the tube head 1 by minimizing the addition of resin in the functional zones. The use of resin in the functional zones is preferable to obtain, ultimately, a tight and operational packaging with respect to the packaged product.

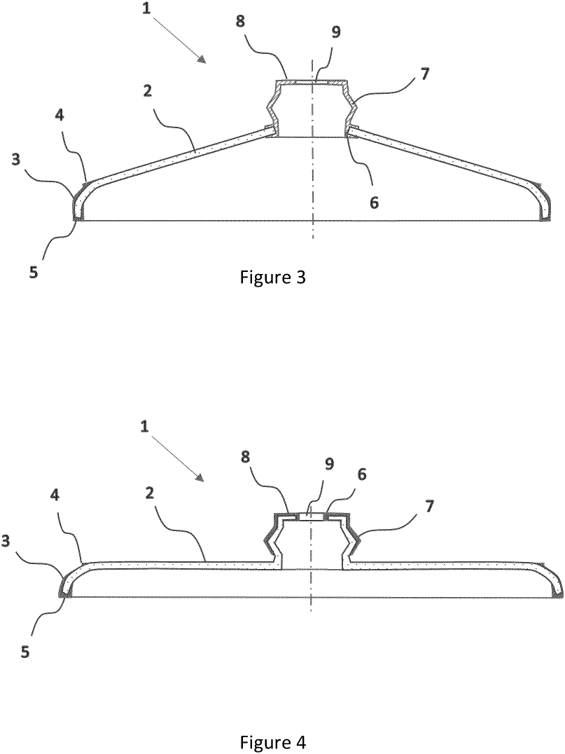

FIG. 3 illustrates a cellulose-based tube head 1 according to the invention. The tube head 1 illustrated in FIG. 3 is similar to that presented in FIG. 1, but has a cellulose-based structural part 2 of conical geometry linking the functional parts 3, 4, 5 situated at the periphery and the functional parts 7, 8, 9 situated in the central part of the head. FIG. 3 illustrates the fact that the cellulose-based structural part 2 can have a complex three-dimensional geometry. This part 2 of the cellulose-based tube head 1 can be obtained from cellulose-based single-layer or multilayer sheets such as formable sheets of paper or cardboard. An alternative consists in manufacturing the structural part 2 of the tube head 1 by cellulose molding.

FIG. 4 illustrates a tube head 1 in which the addition of resin is minimized. In this tube head, the cellulose-based structural part 2 is present in all the parts of the tube head. The functional zones 3, 4, 5, 6, 7, 8 are obtained by the addition of resins in small thickness on top of the structural part 2. It may be advantageous to use a single-layer or multilayer film of resin to produce the functional parts 3, 4, 5, 6, 7 and 8. The use of a film of small thickness which is welded or glued in the functional zones makes it possible to minimize the quantity of resin in the packaging. The tube head 1 presented in FIG. 4 offers the advantage of a very high cellulose content while ensuring a functionality identical to the polyethylene- or polypropylene-based tube heads. The tube head presented in FIG. 4 has a cellulose content greater than 70% and preferably greater than 85%.

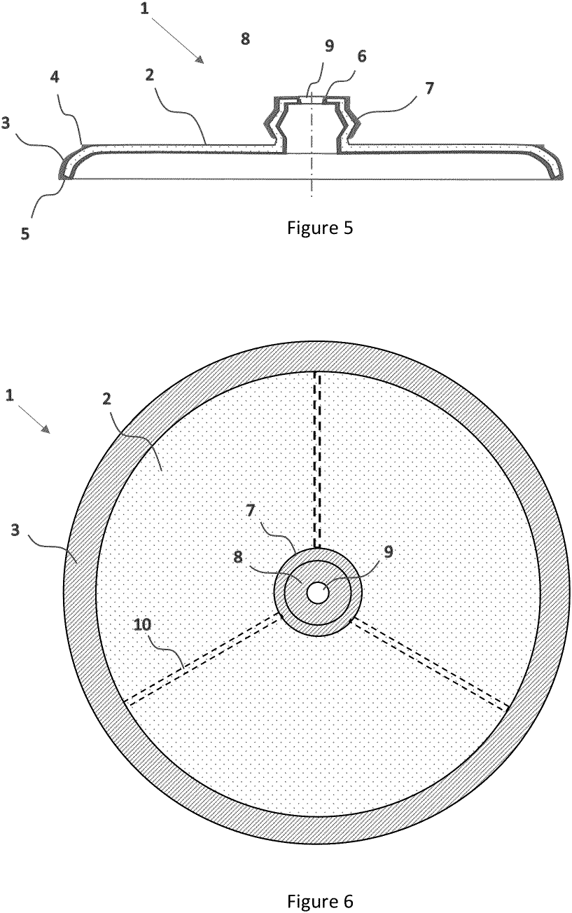

FIG. 5 illustrates a tube head 1 similar to that presented in FIG. 4 but in which the inner surface of the cellulose-based structural part is covered by a functional resin. Advantageously, the functional resin takes the form of a thin single-layer or multilayer film and is welded over at least the periphery in zones 3, 4 and 5. The film can also be welded over the entire inner surface. This variant makes it possible to use, for example, a cellulose-based single-layer structural part 2. This structural part 2 can be pre-manufactured by cellulose molding. The addition of a functional resin covering all the inner surface of the structural part 2 and linking the functional parts 3, 4, 5, 6, 7, 8 makes it possible to make the cellulose-based structural part 2 tight.

Another embodiment of the invention that is not illustrated consists in having a tube head similar to that illustrated in FIG. 5 with the film of synthetic resin of small thickness which covers not only the inner surface of the shoulder but which also blocks the orifice. Thus, the film can be used as packaging tamperproofing telltale, and will have to be perforated upon first use in order to allow the product contained in the packaging to be extracted.

FIG. 6 illustrates an example of a tube head according to the invention in a view from above having ribs 10 of resin linking the central and peripheral functional zones. These ribs 10 make it possible, in an injection method, to manufacture the tube head 1 by overmolding of the cellulose-based structural part 2 by using a single injection point situated in the central part. The resin feeds the peripheral functional zones by passing through the ribs 10. Alternatively, the tube head may not have ribs 10 and the central and peripheral functional parts are injected via separate injection points. Other equivalent methods can be envisaged.

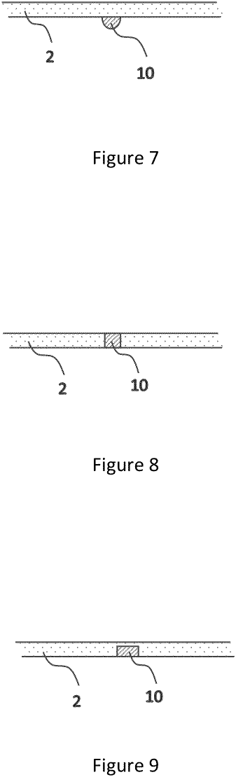

FIGS. 7, 8 and 9 illustrate examples of ribs 10 seen in cross section.

FIG. 7 shows an example of a rib situated on the inner face of the tube head and which stands proud of the surface of the structural part 2.

FIG. 8 shows another example of a rib 10 which is formed by a passage formed in the thickness of the structural part 2. The rib 10 can be obtained by virtue of a suitable geometry of the structural part 2 before the overmolding operation.

FIG. 9 illustrates another example of a rib which is embedded in the structural part 2. Partially embedded ribs can also be produced. Combinations of different ribs are also possible.

FIGS. 10 and 11 illustrate the assembly zone of the tube head 1 and of the tube skirt 11. The assembly can be done by welding or, alternatively, by overmolding. As FIG. 10 shows, the invention makes it possible to encapsulate the ends of the cellulose-based structural part 2 using the resin added in the functional zone 5, to weld the tube head 1 and the skirt 11 using the resin added in the welding functional zone 3 and to encapsulate the end of the skirt 11 using the resin added in the functional zone and forming a staircase 4.

The barrier layers to moisture and to gasses or aromas present in the skirt 11 and in the tube head 1 are not represented because these layers are very thin. It is advantageous for many packagings to have the barrier layer or layers positioned in the thickness of the skirt close to the inner face and to jointly have the barrier layer or layers in the thickness of the tube head positioned close to the outer face. Thus, during the assembly operation (when the tube head is placed inside the skirt to fix them to one another), the barrier layers of the tube head 1 and of the skirt 11 are in proximity to one another, guaranteeing a continuity of the barrier at the weld and consequently a very tight packaging.

In other cases, it is also desirable to limit the migration of the aromas in the wall of the packaging. In this case, it may be advantageous to have, in the thickness of the tube head 1, a barrier layer to the aromas positioned close to the inner surface. This barrier layer can replace or be added to any barrier layers already present on the outer surface of the tube head 1.

Thus, according to the invention, the tube head 1 preferentially has a barrier layer to gasses close to its outer surface while the skirt 11 preferentially has a barrier layer to gasses close to its inner surface. Alternatively, the tube head comprises a barrier layer to gasses or to aromas close to its inner surface. Alternatively, the tube head comprises two barrier layers to gasses and to aromas, a first close to its outer surface and a second close to its inner surface.

Different configurations and positionings of the layer or layers are therefore possible in the context of the present invention, for example depending on the respective positions of the parts and/or on the desired effects.

FIG. 11 illustrates another configuration of assembly of the tube head 1 and of the skirt 11. FIG. 11 illustrates the assembly obtained by welding the tube head 1 and the skirt 11. The assembly is advantageously produced by welding with hot air; one alternative solution consists in using ultrasounds. Other equivalent methods are of course possible.

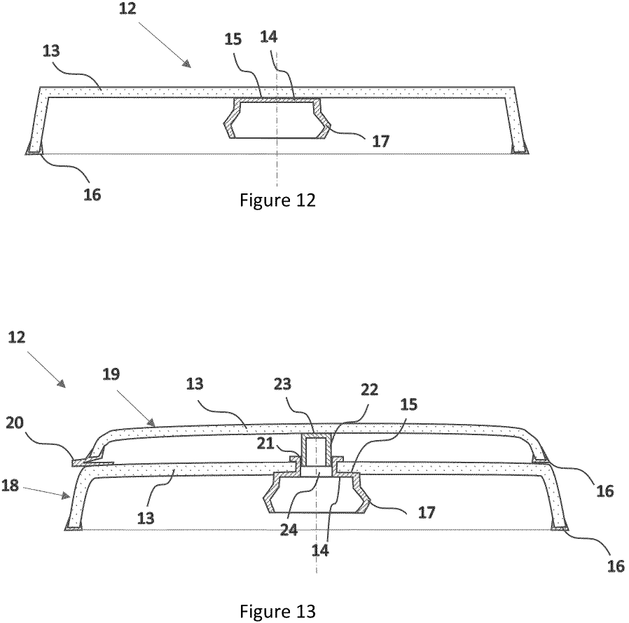

Another aspect of the invention relates to a cellulose-based opening/closure system such as tube caps. FIGS. 12 and 13 illustrate examples of cellulose-based tube caps according to the invention. The tube caps are presented in cross section.

FIG. 12 illustrates an example of a cellulose-based tube cap 12 according to the invention, the cap 12 comprising a first cellulose-based structural part 13 and resin-based functional parts 14 and 17.

The cellulose-based structural part 13 is preferably a multilayer structure with a high cellulose content. The structural part 13 has liquid-resistance properties except at its ends. According to a preferential embodiment, the structural part 13 has a resistance to liquids such as water or oil. Examples of multilayer structures of the structural part 13 are as follows, described from the outer face to the inner face:
paper
paper/PE
paper/PP
coating/paper/PE
coating/paper/PP
coating/paper/coating
PE/paper/PE
PP/paper/PP
coating/PVOH/paper/PVOH/coating.

The thickness of the structural part 13 is between 500 and 1500 microns, and preferably between 700 and 1200 microns. The structural part 13 is advantageously manufactured from a multilayer sheet containing a cellulose content greater than 60% and preferably greater than 80%. The structural part 13 can also be obtained by cellulose molding.

FIG. 12 illustrates a cellulose-based cap comprising the following functional parts:
assembly means 17 for assembling the cap with the tube head,
sealing means 14 between the cap and the tube head,
optionally, an encapsulation zone 16 of the ends of the structural part 13.

These functional parts 14-17 are made of resin such as, for example:
PE or PP or PVOH
PLA or other biosourced resin
biodegradable resins
cold or hot glues.

The interface 15 provides the link between the resin functional part and the resin structural part. The interface 15 can be welded or glued. Overmolding, welding or gluing methods can be envisaged, or other equivalent methods.

The assembly means 17 are used to fix the cap 12 onto the tube head 1 and allow the opening and the closure of the packaging. The fixing means are, for example, a threading if the cap is screwed onto the tube head, or snap-fitting means for example, or other equivalent means.

The cap 12 advantageously has sealing means 14 made of resin to allow the seal with the cap upon the closure of the packaging.

The optional encapsulation zone 16 makes it possible, for example, to protect the ends of the cellulose-based structural part 13 from moisture. More generally, the encapsulation zone 16 avoids the migration of liquid products into the cellulose-based structural part 13. The addition of the encapsulation zone 16 depends on the conditions of use of the packaging and in particular on the environment in which it is used (dry or moist) .

The functional zones 14, 16 and 17 are obtained, for example, by an overmolding method by injection of the cellulose-based structural part 13 (see the application WO 2018/073735 which is incorporated by reference). One alternative method is to use a compression molding method to overmold the cellulose-based structural part 13. Another alternative method is to assemble the central part made of resin by gluing or welding.

FIG. 13 illustrates an example of a hinged cap 12 intended to be fixed onto the tube head 1. The hinged cap 12 is cellulose-based and comprises a seat 18 linked to a cover 19 by a hinge 20. The cap 12 comprises the structural parts 13 of the seat and of the cellulose-based cover. The cap also comprises functional parts made of resin, including assembly means 17, sealing means 14 and 21, a hinge 20 and optional encapsulation zones 16.

The assembly means 17 are used to fix the cap 12 onto the tube head 1 and allow the opening and the closure of the packaging. The fixing means are, for example, a threading or snap-fitting means or other equivalent means.

The cap 12 advantageously has sealing means 14 made of resin to allow the seal between the seat 18 and the tube head 1, and sealing means 21 made of resin making it possible to ensure the seal between the seat 18 and the cover 29.

The hinge 20 made of resin allows the cover to be opened and closed a large number of times.

The optional encapsulation zones 16 protect the ends of the cellulose-based structural parts 13 of the seat 18 and of the cover 19 from moisture.

The functional zones 14, 16, 17, 20 and 21 are obtained, for example, by an overmolding method by injection of the cellulose-based structural parts 13 (see the application WO 2018/073735 which is incorporated by reference). One alternative method consists in using a compression molding method to overmold the cellulose-based structural part 13. Another alternative method consists in assembling the functional parts by gluing or welding.

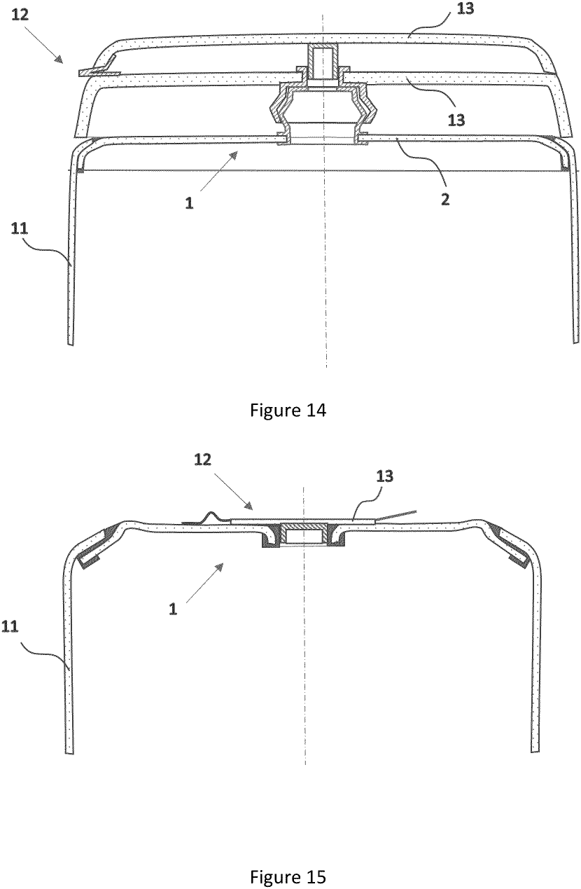

Another aspect of the invention relates to a cellulose-based tube comprising at least a cellulose-based skirt and a cellulose-based tube head or comprising at least a cellulose-based skirt and a cellulose-based cap. FIG. 14 illustrates another subject of the invention which is a cellulose-based tube obtained from the cellulose-based tube head illustrated in FIG. 1 and a cellulose-based skirt 11. This tube is also associated with a cellulose-based cap as illustrated in FIG. 13. The tube without its cap has a cellulose content greater than 50% and preferably greater than 70%. The complete packaging according to the invention, that is to say the tube with its cellulose-based cap, also has a cellulose content greater than 50% and preferably greater than 70%. According to a preferential embodiment, the packaging has an overall cellulose content greater than 85%.

In embodiments, the skirt 11 used in the context of the present invention can be formed from the following materials:
paper/PE or paper/PP or paper/coating
PE/paper/PE or PP/paper/PP or coating/paper/coating
coating/paper/PVOH/PE
PE/paper/PE-EVOH-PE
PE/paper/barrier PET/PE
OPP/paper/barrier OPP/PP
coating/PVOH/paper/PE
PE-EVOH-PE/paper/PE
barrier OPP/paper/PP

FIG. 15 illustrates another example of cellulose-based packaging with a cellulose-based cap 12 directly fixed onto the tube head 1.

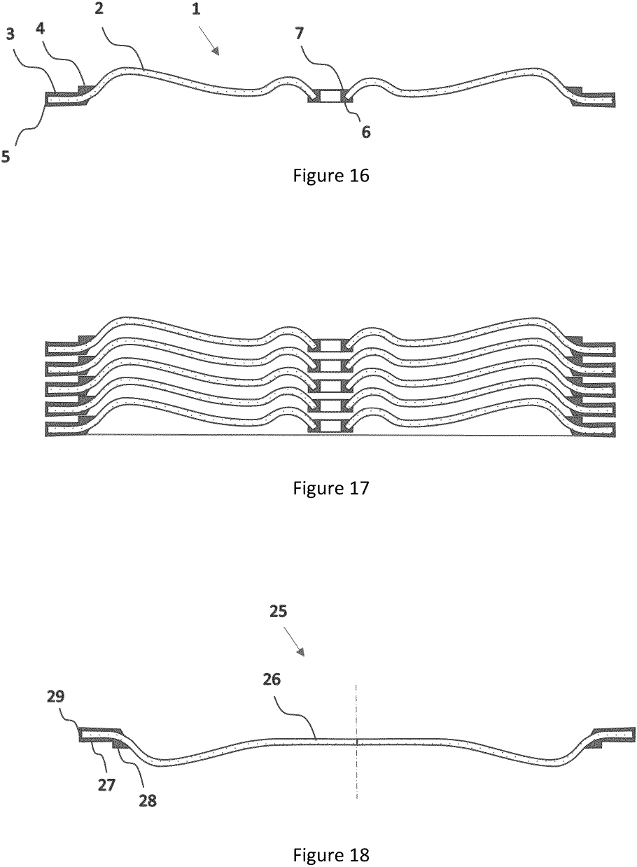

FIG. 16 illustrates a cellulose-based tube head 1 according to the invention which can easily be stacked.

FIG. 17 illustrates the tube head stacking which facilitates handling and storage in the manufacturing process.

FIG. 18 illustrates another example of a packaging component produced according to the invention. FIG. 18 illustrates a cellulose-based packaging bottom 25 intended to be assembled on a cellulose-based packaging body in order to form a bottle or a flask. The bottom 25 comprises a cellulose-based structural part 26 and the resin-based functional parts 27, 28 and 29.

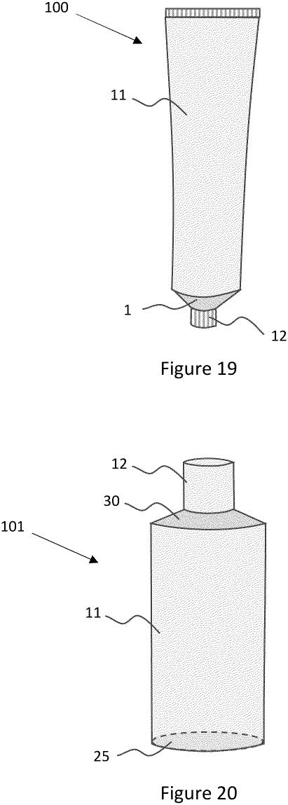

FIGS. 19 to 23 illustrate examples of packagings that can be produced by virtue of the invention.

FIG. 19 illustrates a flexible tube 100 comprising a skirt 11, a tube head 1 and a cap 12. The invention makes it possible to obtain a tube with a high cellulose content. The advantage of the invention is to minimize the addition of resin because this addition is done only in the functional zones situated at the interface between the components as described above.

FIG. 20 illustrates a second example of packaging produced according to the invention which is a flask or a bottle 101 intended to contain liquid products. This flask comprises a skirt 11, a neck 30, a bottom 25 and a cap 12. The thickness of the cellulose-based skirt is adjusted to obtain a sufficiently rigid cylindrical body. This flask or bottle comprises structural parts of the neck, of the bottom and of the cap, mostly cellulose-based. Resin is added locally in the functional parts/zones situated at the interface between the components: for example resin is added advantageously at the join between the bottom 25 and the skirt 11, at the join between the neck 30 and the skirt 11, and at the interface between the neck 30 and the cap 12 according to the principles of the present invention.

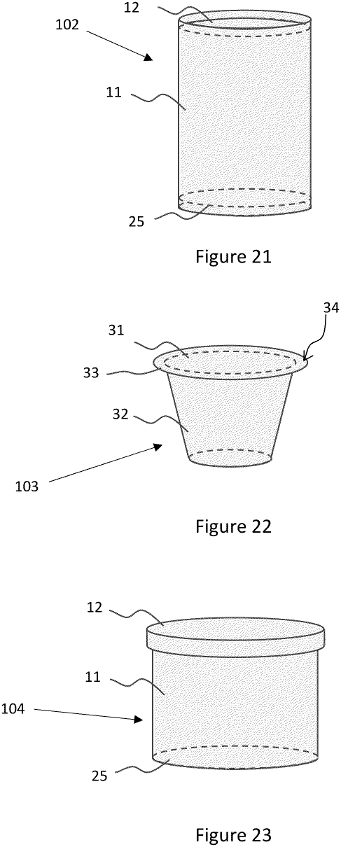

FIG. 21 illustrates a packaging of can type 102 intended to contain powder or granule products, or even liquid products. The can comprises a skirt 11, a bottom 25 and an end provided with an opening system 12 comprising structural parts and functional parts according to the principle of the present invention. The opening system 12 can range from the simplest version like a lid which is torn away upon opening, to the most complex version with a reclosable cap. The invention makes it possible to provide the link between the components of the packaging and ensure its functionality with a limited resin content.

FIG. 22 illustrates a capsule 103 intended to contain products in powder form (for example coffee) or in liquid form. This packaging comprises, as structural parts, a conical body made of cellulose 32 and a lid 31 welded onto the conical body. In some cases, the capsule also comprises a second lid blocking an orifice at the bottom of the capsule. The invention makes it possible to minimize the resin content in the capsule by adding resin only at the collar 33 (functional part 34) to allow the tight weld with the lid 31 and guarantee the functionality of the capsule. For example, for coffee capsules, the addition of resin makes it possible to ensure the seal with the coffee machine when using the capsule.

FIG. 23 illustrates a pot 104 intended to contain pasty or creamy products; or even powder products or products in granulated form. The pot comprises a skirt 11, a bottom 25 and a cap 12 with structural and functional parts as described in the present application. The bottom 12 can be screwed or snap-fitted onto the skirt 11.

This list of examples should not be considered to be limiting, the invention being able to be used advantageously for packagings comprising a high cellulose content and requiring the addition of resin in small quantity in the functional parts as described in detail in the present application.

The embodiments described are done so as illustrative examples and should not be considered limiting. Other embodiments can use means equivalent to those described for example. The embodiments can also be combined with one another depending on the circumstances, or means used in one embodiment can be used in another embodiment.

1. A packaging part, such as a tube, said part being, for example, a tube head or a cap or a bottom or capsule body, said part comprising a structural part and at least one functional part, the structural part having a high cellulose content and the functional part having a lower cellulose content.

2. The packaging part as claimed in claim 1, wherein the cellulose content of the structural part is at least greater than 50%, advantageously greater than 70% and preferably greater than 85%.

3. The packaging part as claimed in claim 1, said structural part having a single-layer or multilayer cellulose-based structure.

4. The packaging part as claimed in claim 1, said part being a tube head or a capsule body.

5. The packaging part as claimed in claim 3, wherein the multilayer structure is, from the outer face toward the inner face:
paper/PE or paper/PP or paper/coating
PE/paper/PE or PP/paper/PP or coating/paper/coating
coating/paper/PVOH/PE
PE/paper/PE-EVOH-PE
PE/paper/barrier PET/PE
OPP/paper/barrier OPP/PP
coating/PVOH/paper/PE
PE-EVOH-PE/paper/PE
barrier OPP/paper/PP.

6. The packaging part as claimed in claim 1, wherein the outer layer is a layer of coating type and/or a lacquer.

7. The packaging part as claimed in claim 4, wherein the structural part is manufactured from a multilayer sheet containing a cellulose content greater than 50%.

8. The packaging part as claimed in claim 4, wherein the tube head comprises at least, as functional part:
a welding zone,
encapsulation zones of the ends of the structural part,
assembly means for assembling the tube head with a cap,
sealing means between the tube head and the cap,
an orifice.

9. The packaging part as claimed in claim 1, said functional part being made of resin such as, for example:
PE or PP or PVOH
PLA or other biosourced resin
biodegradable resins
cold or hot glues
or multilayer.

10. The packaging part as claimed in claim 1, said part being a cap.

11. The packaging part as claimed in claim 10, wherein the multilayer structure of the structural part comprises, for example, from the outer face to the inner face:
paper
paper/PE
paper/PP
coating/paper/PE
coating/paper/PP
coating/paper/coating
PE/paper/PE
PP/paper/PP
coating/PVOH/paper/PVOH/coating.

12. The packaging part as claimed in claim 10, said structural part being manufactured from a multilayer sheet containing a cellulose content greater than 60% and preferably greater than 80%.

13. The packaging part as claimed in claim 10, wherein the cap comprises, at least as functional part:
assembly means for assembling the cap with the tube head,
sealing means between the cap and the tube head,
an encapsulation zone of the ends of the structural part.

14. The packaging part as claimed in claim 10, wherein the functional part is made of resin such as, for example:
PE or PP or PVOH
PLA or other biosourced resin
biodegradable resins
cold or hot glues
or multilayer.

15. The packaging part as claimed in claim 1, said part being a packaging bottom.

16. The packaging part as claimed in claim 15, said bottom comprising a cellulose-based structural part and resin-based functional parts.

17. A packaging comprising at least one part as defined in claim 1 .

18. The packaging as claimed in claim 17, said packaging being a tube or a flask, or a bottle, or a can, or a capsule or a pot.

19. The packaging as claimed in claim 17, said packaging having a cellulose content greater than 50% and preferably greater than 70%, or preferentially an overall cellulose content greater than 85%.
